(19) United States
(12) Patent Application Publication
(10) Pub. No.: US 2021/0255609 A1
(43) Pub. Date: Aug. 19, 2021

(54) SYSTEMS AND METHODS FOR MONITORING AND PREDICTING A RISK STATE OF AN INDUSTRIAL PROCESS

(71) Applicant: ExxonMobil Research and Engineering Company, Annandale, NJ (US)

(72) Inventors: Thomas S. Copeland, League City, TX (US); Benjamin G. Knott, The Woodlands, TX (US); Liezhong Gong, Basking Ridge, NJ (US); C. Gustavo Machado, Curitiba (BR); Kenneth G. Teague, Conroe, TX (US)

(21) Appl. No.: 17/148,755

(22) Filed: Jan. 14, 2021

Related U.S. Application Data
(60) Provisional application No. 62/976,366, filed on Feb. 14, 2020.

(51) Int. Cl. G05B 19/418; G06F 16/9035

(52) U.S. Cl. CPC G05B 19/41865; G06F 16/9035; G05B 19/4183; G05B 19/4184

(57) ABSTRACT

A method of determining a risk state for a complex industrial process includes graphically depicting a process flow diagram on a graphical user interface with a computer system, the process flow diagram including one or more side streams of the complex industrial process, monitoring one or more process parameters of the one or more side streams, and calculating a risk state for each side stream with the computer system based on the one or more process parameters. The risk state of each side stream is then graphically depicted on the process flow diagram by assigning a probability indicator to each side stream based on the risk state calculated by the computer system, wherein the probability indicator comprises a graphical output recognizable by a user and corresponding to a predetermined scale of failure probability.

### CROSS REFERENCE TO RELATED APPLICATION

This application relates and claims priority to U.S. Provisional Patent Application No. 62/976,366, filed on Feb. 14, 2020, which is incorporated herein specifically by reference.

### FIELD OF INVENTION

This application relates to generating and presenting a risk state of a complex industrial process utilizing a graphical user interface to monitor and predict failure risk.

### BACKGROUND

Complex industrial processes (e.g., petrochemical refining) require massive capital expenditures to develop and operate. Downtime caused by equipment failure or to conduct regular maintenance may result in significant revenue loss. Operational flexibility to maximize revenue opportunities is also difficult with complex industrial processes. Understanding the effects of varying the operating parameters of the industrial process can be time intensive and require significant engineering experience and effort.

Maintaining a complex industrial process is an important part of business profitability. Petrochemical refining operations, for example, represent billions of dollars invested in building and operating a refinery. Large engineering teams are employed to monitor and maintain the equipment and processes so that revenue is not lost and catastrophic failures are prevented. Complex custom failure models are sometimes used to predict the failure of specific components and/or systems of components within a process. Applying the failure models typically requires trained engineers and scientists to perform the analysis. The current analysis methods are custom developed, application specific models that require many hours of labor and do not provide graphical/visual output that helps identify portions of the process that may need attention.

Another issue is that potentially profitable business opportunities to refine different grades of crude oil arise periodically. Different crude oil grades may have physical properties (e.g., acid levels) that detrimentally impact portions of a petrochemical refining process or require refining inputs that change the operational cost of refining. Before a business decision is made to run different crude oil grades, the engineering team must undertake a time-intensive analysis of the effects of changing process parameters for refining diff crude oil grades to understand the risk of equipment failure and/or wear. The engineering analysis can also add significant expense, thereby reducing the flexibility of the business operations to maximize profits while minimizing risk of equipment failure. The windows of opportunity are often relatively short and thus timely analysis is critical to maximizing revenue opportunities. The business decisions to refine different grades of crude oil and/or change downtime schedules may easily have multimillion dollar impacts of the revenue generated by the refinery.

Thus, there is a need for a method of monitoring failure risk of complex industrial processes that provides fast visual results so that engineering and business resources can manage downtime and optimize operations. Furthermore, there is a need for a method that allows business operations to quickly predict the future failure risk as a result in changing process parameters in response to business opportunities so that decisions can be made to optimize revenue.

### SUMMARY OF INVENTION

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspects, a method of determining a risk state for a complex industrial process is disclosed and may include graphically depicting a process flow diagram on a graphical user interface with a computer system, the process flow diagram including one or more side streams of the complex industrial process, monitoring one or more process parameters of the one or more side streams, and calculating a risk state for each side stream with the computer system based on the one or more process parameters. The method may further include graphically depicting on the process flow diagram the risk state of each side stream by assigning a probability indicator to each side stream based on the risk state calculated by the computer system, wherein the probability indicator comprises a graphical output recognizable by a user and corresponding to a predetermined scale of failure probability.

In one or more additional aspects, a method of determining a predicted risk state for a complex industrial process is disclosed and may include graphically depicting a process flow diagram of the complex industrial process on a graphical user interface with a computer system, monitoring one or more process parameters of the complex industrial process, and calculating a current risk state for the complex industrial process with the computer system based on the one or more process parameters. The method may further include manually inputting a future date and an alteration to the one or more process parameters, calculating a predicted risk state for the complex industrial process with the computer system based on the future date and the alteration to the one or more process parameters, and graphically depicting on the process flow diagram the predicted risk state of the complex industrial process by assigning a probability indicator to each portion of the complex industrial process based on the risk state calculated by the computer system. The probability indicator may comprise a graphical output recognizable by a user and corresponding to a predetermined scale of failure probability.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a process flow diagram of a portion of a petrochemical refining process incorporating a current risk state;

FIG. 2 illustrates a portion of graphical user interface depicting a process flow diagram of a petrochemical refining process incorporating a predicted risk state; and

FIG. 3 is a schematic diagram of the computer system of FIG. 1.

### DETAILED DESCRIPTION

This application relates to generating and graphically depicting a risk state of an industrial process to help monitor and predict failure risk and to guide decisions about operating the industrial process.

A “risk state” is defined and used herein as the probability of failure of one or more of the individual components (equipment) and/or groups of components in a complex industrial process. There are many different types of failures that might occur for a particular component or group of components. With respect to petrochemical refining in the oil and gas industry, for example, one common type of failure is related to corrosion of the pipes and associated equipment in atmospheric distillation tower systems caused by the chemical properties of the materials being refined and the process parameters of the refining process. For example, the acid content, process temperatures, and material velocities (flowrate) throughout a refining process will contribute to corrosion and metal loss of the refining equipment at different rates throughout different portions of the process.

The bulk of the present disclosure is related to monitoring and managing complex refining systems associated with the oil and gas industry and providing a visual tool that depicts a risk state focused on corrosion failures that might occur in atmospheric distillation tower systems. However, it is contemplated herein that the disclosed systems and methods may be used in conjunction with any type of complex industrial process and for any type of failure mode. For example, the principles of the present disclosure may be equally applicable to other industries such as, but not limited to, food processing and production, chemical processing and production, paint processing and production, medicine processing and production, paper/pulp, foundries and forges, power generation, waste processing, and others.

Modern engineering techniques are capable of modeling/predicting failure of most electrical, mechanical, and chemical processes that would comprise a complex industrial process. One of ordinary skill in the art would be capable of applying such techniques to determine the probability of failure of a specific component. It is also contemplated that the general knowledge of corrosion models used in calculating and predicting the risk of a component failure are well known to one of ordinary skill in the art.

Complex industrial processes, such as the atmospheric distillation tower systems described herein, may contain hundreds or thousands of components that require monitoring for corrosion. Part of normal operations include periodic measurements to determine how much corrosion and/or metal loss has taken place over time inside a specific piece of pipe (conduit) or equipment. The obvious downside of this is that the system must sometimes be shut down for physical inspections and measurements. Downtime is expensive and must be minimized to ensure financial viability of a complex industrial process, and such business decisions could have large financial impacts on the facility. As a result of the demanding economic circumstances, physical inspections are rare and math-based models that calculate the expected corrosion are used instead to predict the current and future conditions of components.

Modeling corrosion over time requires knowing the process parameters (e.g., acid content, temperatures, flow rates, etc.) experienced by individual pieces of equipment and plumbing over time. Different components (equipment) at different locations in the same system will be subjected to (experience) different process parameters that will affect the corresponding corrosion rate differently. The corrosion modeling process is complex, requires daily process data, and is time intensive as each component is commonly modeled separately. For instance, the process to update a complete corrosion risk state for an atmospheric distillation tower system can require hundreds of engineering man hours.

Automating the process of data capture and model calculations is not a complete solution. The corrosion model needs to be applied individually to each component that may potentially fail. Thus the hundreds and possibly thousands of results from the corrosion model need to be aggregated into a format that highlights the probability of any one component and/or system failure and the location of said component and/or system.

Furthermore, merely knowing the risk state at a specific moment in time in comparison to past process data is useful but not completely relevant to the business team trying to decide how to operate the complex industrial process (refinery) in the future. Current planning processes require the refinery planning/management team to direct the engineering team to calculate the impact of opportunistic process changes (i.e., processing different quality crude materials). Even with an automated process, a significant amount of engineering effort is required so that the planning/management team can make decisions. Moreover, how the data is presented and interpreted is a significant part of making decisions. The personnel that plan operations may not know the specific details of the process flow and/or locations of the equipment and/or components that could be impacted. Thus, providing the planning/management team with results generated and asking the team to decide what to do may not be effective. Rather, the team may need guidance on how to interpret the information provided by the results.

The present disclosure provides methods and systems for calculating and presenting a risk state of a complex industrial process and providing a user-friendly, visual output that can be displayed on a graphical user interface for consideration by a user (e.g., an engineer, a planner, an operator, a manager, etc.). As described herein, the visual output (depiction) includes a simplified process flow diagram or “map” that indicates process flows, equipment components, and/or equipment circuits included in the industrial process. A computer system may be programmed to run an automated model that utilizes captured process data and process history to determine the failure probability of individual components or equipment of the industrial process. The computer system may then visually represent the failure probability of individual components (equipment) and/or groups of components on the process flow diagram and corresponding to the location of the equipment in the process flow.

In some aspects, the probability of failure may be visually coded within the depiction so that the user can readily see the different probabilities of failure for different portions of the process flow diagram. In some aspects, the user may have the option to change process parameters, materials, and/or properties of the materials being processed. In such aspects, running the model may alternatively be able to predict a future risk state for some or all of the components (equipment) of the process and based on the desired changes to the process parameters. As will be appreciated, the visual depiction of current or future risk states may be advantageous in planning long-term operations of the complex industrial process.

According to the principles described herein, the process of determining the current or future risk state is automated and thus completed in minutes instead of consuming many hours of engineering resources as it has been done in the past. Providing a nearly instantaneous predicted risk state may have numerous advantages for the planning/management team and for the engineering team. Engineers, for example, may be able to spend more time focused on preventing problems and maintaining the processes and less time performing the analysis. Moreover, providing the planning/management team the ability to predict the future risk state may help to decide on advantageous business opportunities and thus maximize revenue. Furthermore, by understanding how changing the process parameters will impact the process, the engineering and operations teams may be able to respond to planning/management team decisions proactively. The ability to predict future risk states based on parameter changes may allow more flexible operations and advantageous downtime planning that results in maximizing revenue opportunities.

Moreover, graphically depicting a risk state for various components (equipment) of a complex industrial process has numerous advantages. The visual depiction improves safety by highlighting areas, systems, and/or components that may require immediate attention. For instance, the visual depiction may direct engineers to portions of the process that need preventive maintenance and allow the operations team to more efficiently schedule downtime, thus minimizing lost revenue. Also, the risk state includes the probability of failure visually coded in the graphical depiction. Thus, a highly skilled engineer or scientist is not required to perform all of the data interpretation. Rather, a nonskilled person can be easily trained to perform a basic evaluation of the system from the visual depiction of the current or future risk state. A daily review of the current risk state may be an advantageous way to improve operations by providing sophisticated analysis in a time scale that was not possible before and with results that can be used by non-technical staff and technical staff simultaneously.

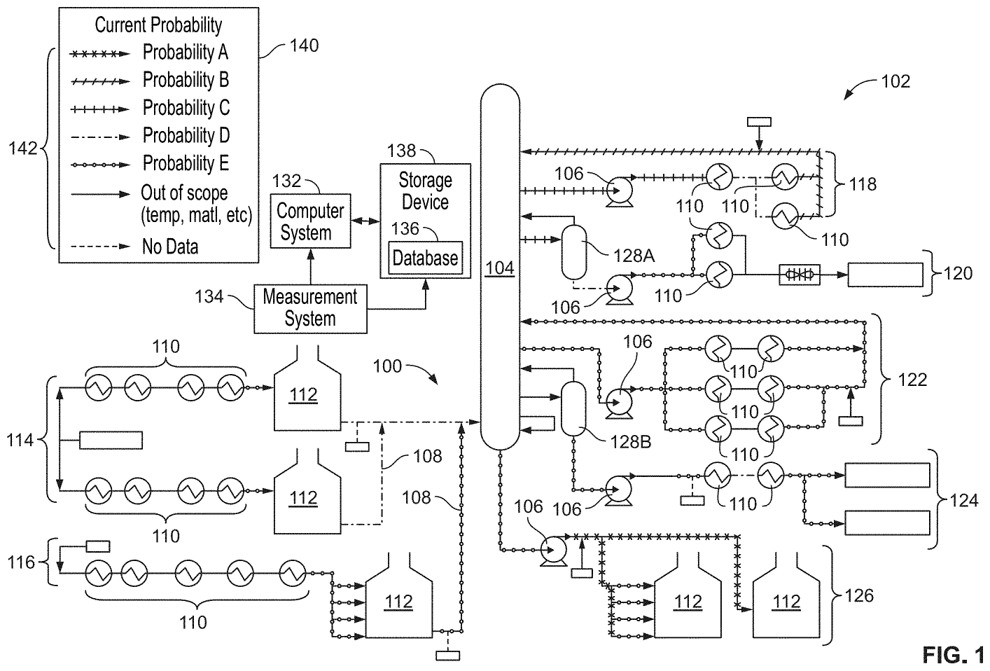

Turning now to FIG. 1, an example process flow diagram 100 for a complex industrial process 102 is depicted, according to one or more aspects of the disclosure. In the illustrated example, the complex industrial process 102 (hereafter “the process 102”) comprises an example hydrocarbon refining process for the oil and gas industry, and the process flow diagram 100 graphically depicts various equipment, plumbing (i.e., conduits, piping, flow lines, etc.), and valving required to receive, circulate, treat, and refine various types of crude oil. In other aspects, however, the process flow diagram 100 may be associated with another type of process 102, including a complex industrial process related to any of the industries mentioned herein, without departing from the scope of the disclosure.

As illustrated, the process flow diagram 100 includes an atmospheric distillation tower 104 that receives crude oils (e.g., hydrocarbons) in various conditions, and fractionates the crude oils into different products. The process flow diagram 100 also includes one or more pumps 106 and associated conduits or pipes 108 used to circulate the crude oil and resulting products through the process 102. The process 102 also includes one or more heat exchangers 110 and furnaces 112 configured to regulate the temperature of the crude oil and the resulting products discharged from the atmospheric distillation tower 104.

In the illustrated example, the atmospheric distillation tower 104 is capable of receiving crude oil from a first feed stream 114 and a second feed stream 116. The first and second feed streams 114,116 may alternately be referred to herein as “side streams.” In at least one example, the first feed stream 114 may provide desalted crude oil, and the second feed stream 116 may provide crude oil from storage tanks and/or an alternative crude oil feed. As will be appreciated, however, the first and second feed streams 114, 116 may alternatively provide other types of crude oils, without departing from the scope of the disclosure. The crude oil provided through the first and second feed streams 114, 116 is circulated through a series of heat exchangers 110 and one or more furnaces 112 before being introduced into the atmospheric distillation tower 104 at preferred conditions. One having skill in the art will understand that the crude oil provided to the atmospheric distillation tower 104 through the first and second feed streams 114, 116 may have undergone any number of processing steps or different types of processing and/or refining required before entering the process 102 for atmospheric distillation.

The heated crude oil is fractionated into different products along the height of the atmospheric distillation tower 104, and various product streams are discharged from the atmospheric distillation tower 104, as shown in the process flow diagram 100 to the right of and below the atmospheric distillation tower 104. More specifically, the process flow diagram 100 depicts a first product stream 118, a second product stream 120, a third product stream 122, a fourth product stream 124, and a fifth product stream 126. Similar to the first and second feed streams 114,116, the product streams 118-126 may alternately be referred to herein as “side streams.”

As illustrated, the first, second, third, and fourth product streams 118, 120, 122, 124 may each include a pump 106 and one or more heat exchangers 110. Moreover, the second product stream includes a first product side stripper 128a and an air-cooled heat exchanger 130, and the fourth product stream 124 includes a second product side stripper 128b. The fifth product stream 126 includes a pair of furnaces 112. After the distilled oil fractions are circulated through the one or more of the product streams 118, 120, 122, 124, 126, the distilled oil fractions may be transferred out of the process 102 and, therefore, out of the process flow diagram 100 for downstream processing or consumption.

The process flow diagram 100 includes process flow lines with arrows that connect the different process points and pieces of equipment corresponding to the pipes 108. The lines and arrows generally indicate the flow direction of the crude oil and products throughout the process 102. One of ordinary skill in the art will understand that the depicted process flow diagram 100 is a significantly simplified version and that each section of pipes 108 may include numerous sections of pipe, conduits, valving, and/or additional equipment not depicted in FIG. 1.

According to aspects of the present disclosure, the process flow diagram 100 may be graphically represented on a graphical user interface and linked live to all valid inputs to the process 102 for calculating risk assessment, thus providing a user with current risk assessment of the entire process 102 based on current process parameters. It is contemplated that the current risk assessment may be updated with data captured hourly, daily, or continuously. The frequency of data capture and update of the risk assessment calculations may be customized depending on the requirements of the process being monitored. Aspects of the present disclosure may also enable users to obtain future risk assessments of the process 102 based on hypothetical alterations to various process parameters. This approach provides dramatically reduced time input to achieve desired understandings and has the unexpected additional outcome of being able to be used by non-expert personnel searching for opportunities to maximize profit at acceptable risk levels.

The process 102 may include a computer system 132 configured to run an automated failure model and generate a graphical representation of the process flow diagram 100 depicting the current and/or future risk state of the various components or grouping of components of the process 102. More specifically, every component (e.g., equipment, pipes 108, valving, etc.) in the process 102 that may be at risk of failure from corrosion may be monitored continuously or intermittently with suitable measurement systems 134 (e.g., sensors, gauges, etc.), all of which may be in communication (either wired or wirelessly) with the computer system 132. The computer system 132 may include or otherwise be in communication with a database 136, which may be stored on a storage device 138, as discussed below. In one aspect, the database 136 may be configured as a data lake. In another aspect, or in addition thereto, the database 136 may be configured as a data warehouse. One or more failure and/or corrosion models specific to each component of the process 102 at risk of failure from corrosion or other methods of failure may also be stored in the database 136. The components may be at risk of failure from corrosion due to, among other things, the type of materials being handled, the process parameters at each component, and the material properties of the specific component.

Upon receiving the data from the measurement systems 134, the computer system 132 may be configured to query the database 136 and calculate a probability of failure for every component in the process 102 based on the corresponding corrosion model(s) associated with each component. All of the components modeled may then be assigned a corresponding probability of failure based on the model calculations. In some aspects, the automated failure model may be configured to group various related components together that comprise a portion of the process flow diagram 100, for example all or a portion of a feed stream 114, 116 or product stream 118-126 (collectively referred to herein as “side streams”), and assign a probability of failure for that portion of the process flow diagram 100. In one or more aspects, the component having the highest calculated probability of failure in a particular grouping may determine the probability of failure for the entire grouping of components.

The computer system 132 may then be configured to combine all the calculations and failure probabilities for each component and/or grouping of components and graphically depict the process flow diagram 100 indicating the current failure risk of the process 102. More specifically, depending on the calculated probability of failure of each component and/or grouping of components, the computer system 132 may be configured to assign or otherwise apply a corresponding probability indicator to the process flow diagram 100 for each component or grouping of components, where the probability indicator is indicative of the current risk of the corresponding component or grouping of components.

To be able to properly interpret the probability indicators applied to the process flow diagram 100, the computer system 132 may also be configured to generate a probability legend 140 and graphically display the probability legend 140 on the graphical user interface for consideration by the user. In the illustrated example, the probability legend 140 indicates five levels or ranges of failure probability: Probability A, Probability B, Probability C, Probability D, and Probability E. Each level is assigned a unique probability indicator 142 that is applied to the flow lines of the process flow diagram 100 to indicate the associated probability of failure with a specific section or portion of the process flow diagram 100.

In the illustrated example, the first and highest probability of failure is Probability A, the second and next lower probability of failure is Probability B, the third and next lower probability of failure is Probability C, the fourth and next lower probability of failure is Probability D, and the fifth and lowest probability of failure is Probability E. Each Probability of failure A-E represents a range of probability failure. In one aspect, Probability A may include all probability of failures calculated that are equal to or greater than 1 in 3 (0.33). Probability B may include all probability of failures calculated that are equal to or greater than 1 in 10 (0.1) and less than 1 in 3 (0.33). Probability C may include all probability of failures calculated that are equal to or greater than 1 in 100 (0.01) and less than 1 in 10 (0.1). Probability D may include all probability of failures calculated that are equal to or greater than 1 in 3000 (0.0003) and less than 1 in 100 (0.01). Probability E may include all probability of failures calculated that are less than 1 in 3,000 (0.0003).

It is contemplated that the specific risk levels and groupings may be industry and/or application specific, and the number of risk levels may also be industry and/or application specific. Accordingly, the number of Probabilities A-E and the types of associated probability indicators 142 are provided merely for illustrative purposes and, therefore, should not be considered limiting to the scope of the disclosure.

The probability legend 140 further includes an “Out of Scope” probability indicator, which may indicate portions of the process flow diagram 100 that are not monitored for the particular failure mode of the process 102. For instance, in the present example, the automated failure model may be configured to calculate failure due to corrosion, and some portions of the process 102 may not be adversely affected by the process parameters (e.g., temperature, pressure, material velocity, acid concentration), thus rendering the corrosion rate of such portions inconsequential. Alternatively, the Out of Scope probability indicator may indicate that some portions of the process flow diagram 100 may not include the sensing infrastructure required to capture all of the required data and/or process parameters for the automated model to perform corrosion calculations

In some aspects, as illustrated, the probability legend 140 may also include a “No Data” probability indicator, which may indicate a portion of the process flow diagram 100 that has no data associated therewith. For example, portions of the process flow diagram 100 including the No Data probability indicator may indicate that the sensing infrastructure or the information technology infrastructure was and/or is down and the relevant data was not recorded as of the running of the automated failure model to generate the process flow diagram 100. In some aspects, the “No Data” probability indicator may indicate a communications failure between the computer system 132, storage device 138, and/or the database 136. It is contemplated that some “No Data” indicators may be remedied by the user forcing the computer system 132 to repeat the process of generating the risk state displayed in the process flow diagram 100. It is also contemplated that some components of the process 102 may be purposely excluded and thus are not included in the failure calculations.

The probability indicators 142 applied to the process flow diagram 100 can comprise any visual feature or graphical output that can be visually and readily recognized by the user and correspond to a predetermined scale of failure probability. In some aspects, for example, each probability indicator 142 may comprise a color-coded line. In such aspects, the failure probability of the component and/or grouping of components would be displayed on the process flow diagram 100 based on a predetermined color scheme, where each color represents or otherwise corresponds to a known range on the scale of failure probability. A red line, for instance, might correspond to Probability A, an orange line might correspond to Probability B, a yellow line might correspond to Probability C, a green line might correspond to Probability D, and a blue line might correspond to Probability E. As will be appreciated, other colors may be used for the Probabilities A-E, and more than five Probabilities may be employed in more than five probability ranges as desired, and depending on the application.

In other aspects, as depicted in the example of FIG. 1, the probability indicators 142 may comprise different (unique) types or designs of dashed or segmented lines. As illustrated, each type of dashed line corresponds to one of the Probabilities A-E, and is mirrored on the process flow diagram 100 to indicate the corresponding components and/or grouping of components having a failure risk commensurate with the associated Probability A-E. In yet other aspects, other types of probability indicators may comprise animations and/or flashing indicators to indicate the corresponding components and/or grouping of components having a failure risk commensurate with the associated Probability A-E. In some aspects, the intensity of the animation or flashing indicator may represent a known range of failure probability. In at least one aspect, the probability indicators 142 may comprise ornamental lines, where each probability indicator 142 provides a unique ornamental design indicative of the corresponding Probability A-E. In yet other aspects, other types of probability indicators 142 may be employed, without departing from the scope of the disclosure.

Example operation of determining the current risk state for the process 102 is now provided. Relevant process parameters and measurement data are captured automatically (or on command) via the measurement system 134 and/or through manual entry and provided directly to the computer system 132 or otherwise stored in the database 136 for future use. The automated model is then run by the computer system 132 to calculate the failure probability for each component and then generate a risk state dependent on the groupings and levels, as discussed above. The computer system 132 may be programmed or otherwise configured to generate a visual representation of the current risk state that may be displayed and viewable as the probability indicators 142 within the process flow diagram 100. Because the current risk state may be calculated in a time frame that is orders of magnitude faster than engineers and scientists manually performing the calculations would require, it is possible to update the risk state on a regular basis or as needed.

The refresh cycle for updating may depend on the process being monitored and/or the volume of data and computing power required. In some aspects, the current risk state may only need to be updated once every 24 hours. In other aspects, the current risk state may be updated more frequently as required by the process parameters and the aspects of the process that the automated model is monitoring. It is also contemplated that multiple failure models may be run by the computer system 132 simultaneously. A model that calculates the probability of failures for pumps and motors may be used to generate a separate risk state or may be integrated into the risk state for corrosion failures. It is contemplated that any type of failure that may be modeled for a portion or component of a complex industrial process may be used to generate a risk state or may be integrated into a risk state.

The process flow diagram 100 of FIG. 1 depicts one possible current risk state, as indicated by the several probability indicators 142. As illustrated, the probability indicators 142 displayed on the process flow diagram 100 range from Probability A to Probability E. Those components or grouping of components in the process 102 that are assigned Probably A are determined to be at the highest probability level of risk for corrosion failure. In contrast, the components or grouping of components in the process 102 that are assigned Probability E are determined to be at the lowest probability level of risk for corrosion failure. By considering the process flow diagram 100 and noting the areas of Probability A-E, a user may be able to make intelligent business and/or operating decisions.

It is contemplated that in petroleum refining processes where a failure may have significant health and safety risks, components or grouping of components in the process 102 that are calculated with the highest probability of failure, Probability A, may require a shutdown of that portion of the process 102 and/or a complete shutdown of the process 102. Consequently, the current risk state graphically displayed in the process flow diagram 100 may be used as a safety tool that may be monitored by non-technical staff for safety issues and business decisions.

Based on the results generated and displayed on the process flow diagram 100 and the reported probabilities of failure for the process 102, a user may then decide to undertake one or more remedial courses of action to mitigate or prevent additional corrosion or component failure. One remedial course of action that may be undertaken includes adjusting a maintenance schedule for a particular side stream. Another remedial course of action that may be undertaken includes altering one or more process parameters of a particular side stream. Other courses of action that may be contemplated include a detailed analysis of model inputs and/or parameters; altering one or more process parameters of the overall feed input; reevaluation of the equipment/component condition; and reevaluation of the risk tolerance for specific components, groups of components, and/or side streams. It is also contemplated that the user may decide that no response is required and the complex industrial process is allowed to continue as presently configured.

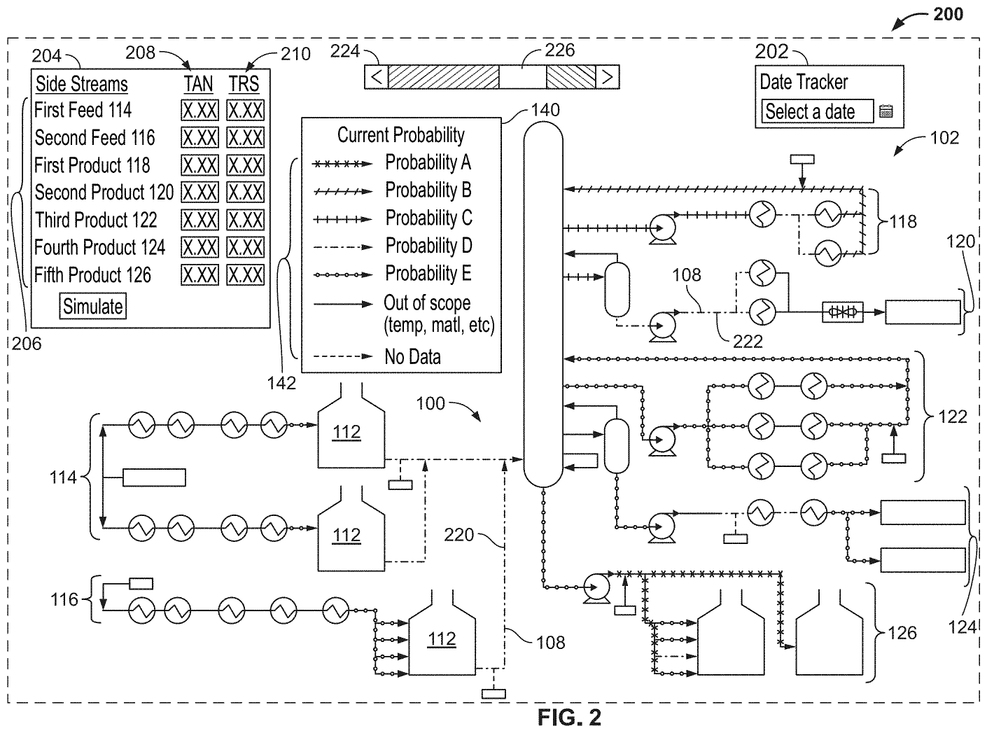

Turning now to FIG. 2, illustrated is at least a portion of an example graphical user interface 200 that can be provided to a user to present current and/or future risk states of the process 102. As illustrated, the graphical user interface 200 (hereafter “GUI 200”) graphically displays the process flow diagram 100 and the probability legend 140 described above with reference to FIG. 1. The process flow diagram 100 depicted in FIG. 2 is similar to the process flow diagram 100 of FIG. 1, except that a portion of the pipes 108 are indicated by different probability indicators 142. The different probability indicators 142 indicate that a different probability of failure has been calculated and represents a future probability of failure corresponding to a predetermined time in the future, as will be described below.

Also included in the GUI 200 may be a date entry field 202 and a process parameters table 204. In the present example, the GUI 200 may be configured to display the process flow diagram 100 in a predicted or future risk state, and it is contemplated that the predicted risk state may be generated by a user (e.g., engineer, planner, operations personnel) based on user inputs. More specifically, the user may be able to manually enter a predetermined, future date in the date entry field 202 at which point it is desired to obtain a future risk probability of the process 102. The user may also be able to manually enter applicable process parameters in the process parameters table 204 that may affect how the process 102 operates. More specifically, the process parameters table 204 may include a listing of various side streams 206 corresponding to portions or sections of the process flow diagram 100. In the illustrated example, the example side streams 206 include the first and second feed streams 114, 116 and the product streams 118-126 of FIG. 1. The side streams 206 may have a variety of fluids and materials circulating therethrough including, but not limited to, reduced crude, whole crude, atmospheric light gas oil (ALGO), atmospheric heavy gas oil (AHGO), VacFeed (i.e., feed to the vacuum (or atmospheric) tower 104), bottoms off the vacuum tower (RESID), vacuum heavy gas oil (VHGO), naphtha, light ends, kerosene, diesel fuel, gasoline and/or any petroleum distillate generally produced during refining operations of crude petroleum.

In some aspects, the value of the process parameters for each side stream 206 may correspond to one or both of a naphthenic acid (TAN) value 208 and a reactive sulfur (TRS) value 210 anticipated to be run through the particular side streams 206. In such aspects, separate values for TAN 208 and TRS 210 may be entered by the user for each side stream 206, and changing the TAN 208 and TRS 210 values will affect current and future operation and the predicted risk state of the corresponding side stream 206.

Based on the user-identified date entered in the date entry field 202 and the values entered for the side streams 206, the computer system 132 (FIG. 1) may be programmed and otherwise configured to run the automated model to calculate the predicted erosion and/or other failure mode(s) from the current risk state until the date entered into the date entry field 204. A visual representation of the predicted risk state may then be generated and displayed by the computer system 132 on the GUI 200 with appropriate probability indicators 142 incorporated into the process flow diagram 100. The predicted risk state graphically shows how changing the process parameters impacts the probability of failure of any individual side stream 206 depending on the granularity of the process flow diagram 100.

For example, a first pipe 220 included in the second feed stream 116 feeds flow from one of the furnaces 112 to the combined flows of other furnaces 112 included in the first feed stream 114 and into the atmospheric distillation tower 104. In the current risk state calculated and depicted in FIG. 1, the same first pipe 220 is depicted with a probability indicator 142 corresponding to Probability E (less than 0.0003) of a corrosion failure. In the predicted risk state of FIG. 2, however, the risk state has changed to a higher Probability D (less than 0.01 greater than or equal to 0.0003) of a corrosion failure. As another example, a second pipe 222 corresponding to the second product stream 120 indicates a Probability E (less than 0.0003) of a corrosion failure in the current risk state of FIG. 1. In contrast, the second pipe 222 indicates a higher Probability D (less than 0.01 greater than or equal to 0.0003) in the predicted risk state of FIG. 2.

The changes in the probability indicators 142 for the first and second pipes 220, 222 indicate that the probability of failure increased as a result of the process parameter changes and the passage of time. As will be appreciated, knowledge that the risk state changes with changing parameters over time may enable the engineering staff and/or operations/planning team to make operations decisions and business decisions to reduce/minimize downtime and/or process different materials that require different process parameters safely and efficiently. The more efficiently the process is operated improves the revenue potential while maximizing safety at the same time.

As can be appreciated, knowing a specific predicted risk state in the future can be valuable, but knowing exactly when the failure risk will change probability levels may also be useful. In one or more aspects, the GUI 200 may further include a time selection tool 224 that may be manually manipulated by the user to adjust the time of the predicted risk state and thereby determine when and how the risk state changes based on changes in the process parameters over time. In such aspects, it is contemplated that a user may enter a future date and new process parameter(s) to generate the predicted risk state, which will be depicted in an updated version on the process map 100. Then, the user may alter the date of the predicted risk state by utilizing (operating) the time selection tool 224. In the present example, the time selection tool 224 comprises a type of sliding time scale that includes a slider 226 capable of moving the predicted date forward or backward in time. Using the cursor of a mouse or another interactive tool, the user may be able to click on the arrows at each end of the time selection tool 224 or alternatively grasp onto and move the slider 226 within the time selection tool 224. Movement of the slider 226 to the left will correspondingly move time backward from the time initially inputted by the user, and moving the slider 226 to the right will correspondingly move time forward.

As the slider 226 moves, the computer system 132 (FIG. 1) may be programmed and otherwise configured to continuously calculate and update the future risk projections corresponding to the selected date as indicated by the slider 226 and based on the process parameters inputted into the side streams 206. The user may then watch the GUI 200 for changes in the predicted risk state that are graphically represented by changing probability indicators 142 for each side stream 206.

The time selection tool 224 depicted in FIG. 2 is only one example means of changing the date of the predicted risk state to determine when portions of the predicted risk state change probability levels. In some aspects, a timeline may be included in the GUI 200 that highlights or indicates when probability levels change and allows a user to click on the timeline to identify the date of the change. It is also contemplated that specific dates that indicate changes in probability levels could be listed and selected by the user. One having ordinary skill in the art would understand that any type of visual controller or indicator may be part of the predicted risk state to permit the user to modify the date of the predicted risk state to an exact moment when a portion of the risk state changes.

Based on the results generated and displayed in the GUI 200 on the process flow diagram 100 and the reported probabilities of failure for the process 102, a user may then decide to undertake one or more remedial courses of action to mitigate or prevent additional corrosion or component failure. One remedial course of action that may be undertaken includes adjusting a maintenance schedule for a particular side stream. Another remedial course of action that may be undertaken includes altering one or more process parameters of a particular side stream. Other courses of action that may be contemplated include a detailed analysis of model inputs and/or parameters; altering one or more process parameters of the overall feed input; reevaluation of the equipment/component condition; and reevaluation of the risk tolerance for specific components, groups of components, and/or side streams. A user may decide that a remedial course of action is unnecessary and the complex industrial process is allowed to continue as presently configured. Alternatively, or in addition thereto, a user may be able to make intelligent business and process decisions based on the results generated and the reported probabilities of failure for the process 102. For example, a user may decide to process a different quality or grade of crude oil and/or crude oil that has different TAN 208 and/or TRS 210 values.

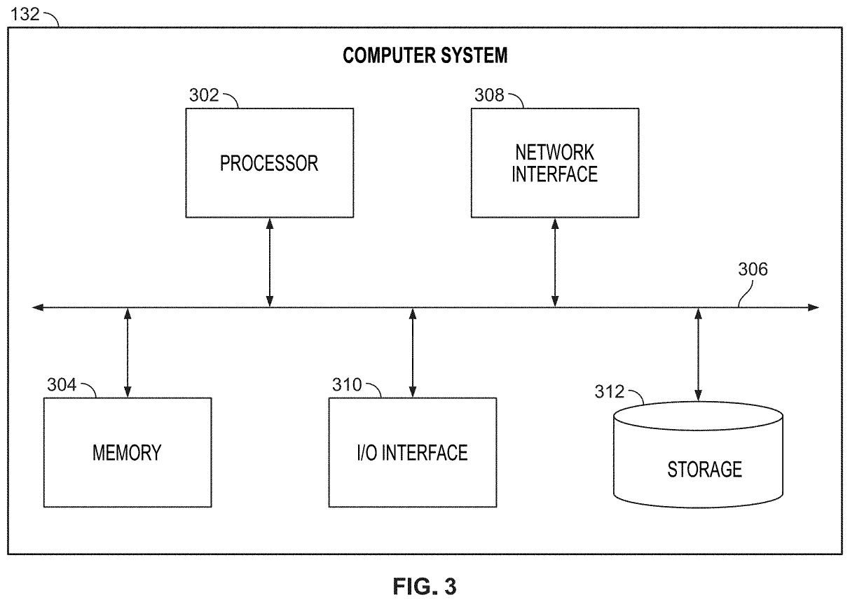

FIG. 3 is a schematic diagram of the computer system 132 of FIG. 1. As shown, the computer system 132 includes one or more processors 302, which can control the operation of the computer system 132. “Processors” are also referred to herein as “controllers.” The processor(s) 302 can include any type of microprocessor or central processing unit (CPU), including programmable general-purpose or special-purpose microprocessors and/or any one of a variety of proprietary or commercially available single or multi-processor systems. The computer system 132 can also include one or more memories 304, which can provide temporary storage for code to be executed by the processor(s) 302 or for data acquired from one or more users, storage devices, and/or databases. The memory 304 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 132 can be coupled to a bus system 306. The illustrated bus system 306 is an abstraction that represents any one or more separate physical busses, communication lines/interfaces, and/or multi-drop or point-to-point connections, connected by appropriate bridges, adapters, and/or controllers. The computer system 132 can also include one or more network interface(s) 308, one or more input/output (TO) interface(s) 310, and the one or more storage device(s) 312.

The network interface(s) 308 can enable the computer system 132 to communicate with remote devices, e.g., other computer systems, over a network, and can be, for non-limiting example, remote desktop connection interfaces, Ethernet adapters, and/or other local area network (LAN) adapters. The IO interface(s) 310 can include one or more interface components to connect the computer system 132 with other electronic equipment. For non-limiting example, the IO interface(s) 310 can include high-speed data ports, such as universal serial bus (USB) ports, 1394 ports, Wi-Fi, Bluetooth, etc. Additionally, the computer system 132 can be accessible to a human user, and thus the IO interface(s) 310 can include displays, speakers, keyboards, pointing devices, and/or various other video, audio, or alphanumeric interfaces.

The storage device(s) 312 can include any conventional medium for storing data in a non-volatile and/or non-transient manner. In some aspects, the storage device(s) 312 may be the same as the storage device 138 of FIG. 1. The storage device(s) 312 can hold data and/or instructions in a persistent state, i.e., the value(s) are retained despite interruption of power to the computer system 132. In at least one aspect, the database 136 of FIG. 1 may be located on the storage device(s) 312. The storage device(s) 312 can include one or more hard disk drives, flash drives, USB drives, optical drives, various media cards, diskettes, compact discs, and/or any combination thereof and can be directly connected to the computer system(s) 132 or remotely connected thereto, such as over a network. In an exemplary embodiment, the storage device(s) 312 can include a tangible or non-transitory computer readable medium configured to store data, e.g., a hard disk drive, a flash drive, a USB drive, an optical drive, a media card, a diskette, a compact disc, etc.

The elements illustrated in FIG. 3 can be some or all of the elements of a single physical machine. In addition, not all of the illustrated elements need to be located on or in the same physical machine. Exemplary computer systems include conventional desktop computers, workstations, minicomputers, laptop computers, tablet computers, personal digital assistants (PDAs), and mobile phones, and the like.

The computer system 132 can include a web browser for retrieving web pages or other markup language streams, presenting those pages and/or streams (visually, aurally, or otherwise), executing scripts, controls and other code on those pages/streams, accepting user input with respect to those pages/streams (e.g., for purposes of completing input fields), issuing HyperText Transfer Protocol (HTTP) requests with respect to those pages/streams or otherwise (e.g., for submitting to a server information from the completed input fields), and so forth. The web pages or other markup language can be in HyperText Markup Language (HTML) or other conventional forms, including embedded Extensible Markup Language (XML), scripts, controls, and so forth. The computer system 132 can also include a web server for generating and/or delivering the web pages to client computer systems.

In an exemplary embodiment, the computer system 132 can be provided as a single unit, e.g., as a single server, as a single tower, contained within a single housing, etc. The single unit can be modular such that various aspects thereof can be swapped in and out as needed for, e.g., upgrade, replacement, maintenance, etc., without interrupting functionality of any other aspects of the system. The single unit can thus also be scalable with the ability to be added to as additional modules and/or additional functionality of existing modules are desired and/or improved upon.

The computer system 132 can also include any of a variety of other software and/or hardware components, including by way of non-limiting example, operating systems and database management systems. Although an exemplary computer system is depicted and described herein, it will be appreciated that this is for the sake of generality and convenience. In other embodiments, the computer system may differ in architecture and operation from that shown and described here.

### Embodiments Listing

The present disclosure provides, among others, the following examples, each of which may be considered as optionally including any alternate example.

Clause 1. A method of determining a risk state for a complex industrial process includes graphically depicting a process flow diagram on a graphical user interface with a computer system, the process flow diagram including one or more side streams of the complex industrial process, monitoring one or more process parameters of the one or more side streams, calculating a risk state for each side stream with the computer system based on the one or more process parameters, and graphically depicting on the process flow diagram the risk state of each side stream by assigning a probability indicator to each side stream based on the risk state calculated by the computer system, wherein the probability indicator comprises a graphical output recognizable by a user and corresponding to a predetermined scale of failure probability.

Clause 2. The method of Clause 1, wherein the complex industrial process includes an atmospheric distillation tower and the one or more side streams include at least one feed stream and at least one product stream, the method further comprising feeding a crude oil to the atmospheric distillation tower from the at least one feed stream, fractionating the crude oil in the atmospheric distillation tower, and discharging a product from the atmospheric distillation tower into the at least one product stream.

Clause 3. The method of Clause 1 or Clause 2, wherein calculating the risk state for each side stream with the computer system comprises querying a database in communication with the computer system for a corrosion model corresponding to each component included in each side stream, applying the corrosion model to each component in each side stream with the computer system based on the one or more process parameters, and assigning the risk state to each side stream based on an output of the corrosion model.

Clause 4. The method of any of the preceding Clauses, wherein monitoring the one or more process parameters for the one or more side streams comprises monitoring the one or more side streams with a measurement system in communication with the computer system.

Clause 5. The method of any of the preceding Clauses, further comprising generating a probability legend with the computer system, and displaying the probability legend on the graphical user interface, the probability legend graphically depicting a plurality of ranges of failure probability on the scale of failure probability, wherein each range of failure probability corresponds to a unique probability indicator.

Clause 6. The method of Clause 5, wherein each unique probability indicator comprises a color-coded line where each color represents a known range of failure probability.

Clause 7. The method of Clause 5, wherein each unique probability indicator comprises a dashed line where each type of dashed line represents a known range of failure probability.

Clause 8. The method of Clause 5, wherein each unique probability indicator comprises an animation or flashing indicator where the intensity of the animation or flashing indicator represents a known range of failure probability.

Clause 9. The method of any of the preceding Clauses, further comprising undertaking a remedial course of action based on the risk state of at least one of the side streams.

Clause 10. The method of Clause 9, wherein undertaking the remedial course of action comprises one or more of the following changing the one or more process parameters, changing a maintenance schedule for a portion of the complex industrial process, shutting down a portion of the complex industrial process, performing maintenance on a portion or component of the complex industrial process, and shutting down the complex industrial process.

Clause 11. A method of determining a predicted risk state for a complex industrial process includes graphically depicting a process flow diagram of the complex industrial process on a graphical user interface with a computer system, monitoring one or more process parameters of the complex industrial process, calculating a current risk state for the complex industrial process with the computer system based on the one or more process parameters, manually inputting a future date and an alteration to the one or more process parameters, calculating a predicted risk state for the complex industrial process with the computer system based on the future date and the alteration to the one or more process parameters, and graphically depicting on the process flow diagram the predicted risk state of the complex industrial process by assigning a probability indicator to each portion of the complex industrial process based on the risk state calculated by the computer system, wherein the probability indicator comprises a graphical output recognizable by a user and corresponding to a predetermined scale of failure probability.

Clause 12. The method of Clause 11, wherein the complex industrial process includes an atmospheric distillation tower and one or more side streams including at least one feed stream and at least one product stream, the method further comprising feeding a crude oil to the atmospheric distillation tower from the at least one feed stream, fractionating the crude oil in the atmospheric distillation tower, and discharging a product from the atmospheric distillation tower into the at least one product stream.

Clause 13. The method of Clause 12, wherein calculating the predicted risk state for the complex industrial process with the computer system comprises querying a database in communication with the computer system for a corrosion model corresponding to each side stream, applying the corrosion model to each side stream with the computer system based on the one or more process parameters, and assigning the risk state to each side stream based on an output of the corrosion model.

Clause 14. The method of any of Clauses 11 through 13, further comprising changing the one or more process parameters to permit processing a different crude oil.

Clause 15. The method of any of Clauses 11 through 14, further comprising generating a probability legend with the computer system, and displaying the probability legend on the graphical user interface, the probability legend graphically depicting a plurality of ranges of failure probability on the scale of failure probability, wherein each range of failure probability corresponds to a unique probability indicator.

Clause 16. The method of Clause 15, wherein each unique probability indicator comprises a color-coded line where each color represents a known range of failure probability.

Clause 17. The method of Clause 15, wherein each unique probability indicator comprises a dashed line where each type of dashed line represents a known range of failure probability.

Clause 18. The method of Clause 15, wherein each unique probability indicator comprises an animation or flashing indicator where the intensity of the animation or flashing indicator represents a known range of failure probability.

Clause 19. The method of any of Clauses 11 through 18, further comprising undertaking a remedial course of action based on the predicted risk state of at least one of the side streams.

Clause 20. The method of Clause 19, wherein undertaking the remedial course of action comprises one or more of the following changing the one or more process parameters, changing a maintenance schedule for a portion of the complex industrial process, and performing maintenance on a portion or component of the complex industrial process.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While systems and methods are described herein in terms of “comprising” various components or steps, the systems and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method of determining a risk state for a complex industrial process, comprising:
graphically depicting a process flow diagram on a graphical user interface with a computer system, the process flow diagram including one or more side streams of the complex industrial process;
monitoring one or more process parameters of the one or more side streams;
calculating a risk state for each side stream with the computer system based on the one or more process parameters; and
graphically depicting on the process flow diagram the risk state of each side stream by assigning a probability indicator to each side stream based on the risk state calculated by the computer system,
wherein the probability indicator comprises a graphical output recognizable by a user and corresponding to a predetermined scale of failure probability.

2. The method of claim 1, wherein the complex industrial process includes an atmospheric distillation tower and the one or more side streams include at least one feed stream and at least one product stream, the method further comprising:
feeding a crude oil to the atmospheric distillation tower from the at least one feed stream;
fractionating the crude oil in the atmospheric distillation tower; and
discharging a product from the atmospheric distillation tower into the at least one product stream.

3. The method of claim 1, wherein calculating the risk state for each side stream with the computer system comprises:
querying a database in communication with the computer system for a corrosion model corresponding to each component included in each side stream;
applying the corrosion model to each component in each side stream with the computer system based on the one or more process parameters; and
assigning the risk state to each side stream based on an output of the corrosion model.

4. The method of claim 1, wherein monitoring the one or more process parameters for the one or more side streams comprises monitoring the one or more side streams with a measurement system in communication with the computer system.

5. The method of claim 1, further comprising:
generating a probability legend with the computer system; and
displaying the probability legend on the graphical user interface, the probability legend graphically depicting a plurality of ranges of failure probability on the scale of failure probability, wherein each range of failure probability corresponds to a unique probability indicator.

6. The method of claim 5, wherein each unique probability indicator comprises a color-coded line where each color represents a known range of failure probability.

7. The method of claim 5, wherein each unique probability indicator comprises a dashed line where each type of dashed line represents a known range of failure probability.

8. The method of claim 5, wherein each unique probability indicator comprises an animation or flashing indicator where the intensity of the animation or flashing indicator represents a known range of failure probability.

9. The method of claim 1, further comprising:
undertaking a remedial course of action based on the risk state of at least one of the side streams.

10. The method of claim 9, wherein undertaking the remedial course of action comprises one or more of the following:
changing the one or more process parameters;
changing a maintenance schedule for a portion of the complex industrial process;
shutting down a portion of the complex industrial process;
performing maintenance on a portion or component of the complex industrial process; and
shutting down the complex industrial process.

11. A method of determining a predicted risk state for a complex industrial process, comprising:
graphically depicting a process flow diagram of the complex industrial process on a graphical user interface with a computer system;
monitoring one or more process parameters of the complex industrial process;
calculating a current risk state for the complex industrial process with the computer system based on the one or more process parameters;
manually inputting a future date and an alteration to the one or more process parameters;
calculating a predicted risk state for the complex industrial process with the computer system based on the future date and the alteration to the one or more process parameters; and
graphically depicting on the process flow diagram the predicted risk state of the complex industrial process by assigning a probability indicator to each portion of the complex industrial process based on the risk state calculated by the computer system,
wherein the probability indicator comprises a graphical output recognizable by a user and corresponding to a predetermined scale of failure probability.

12. The method of claim 11, wherein the complex industrial process includes an atmospheric distillation tower and one or more side streams including at least one feed stream and at least one product stream, the method further comprising:
feeding a crude oil to the atmospheric distillation tower from the at least one feed stream;
fractionating the crude oil in the atmospheric distillation tower; and
discharging a product from the atmospheric distillation tower into the at least one product stream.

13. The method of claim 12, wherein calculating the predicted risk state for the complex industrial process with the computer system comprises:
querying a database in communication with the computer system for a corrosion model corresponding to each side stream;
applying the corrosion model to each side stream with the computer system based on the one or more process parameters; and
assigning the risk state to each side stream based on an output of the corrosion model.

14. The method of claim 11, further comprising changing the one or more process parameters to permit processing a different crude oil.

15. The method of claim 11, further comprising:
generating a probability legend with the computer system; and
displaying the probability legend on the graphical user interface, the probability legend graphically depicting a plurality of ranges of failure probability on the scale of failure probability, wherein each range of failure probability corresponds to a unique probability indicator.

16. The method of claim 15, wherein each unique probability indicator comprises a color-coded line where each color represents a known range of failure probability.

17. The method of claim 15, wherein each unique probability indicator comprises a dashed line where each type of dashed line represents a known range of failure probability.

18. The method of claim 15, wherein each unique probability indicator comprises an animation or flashing indicator where the intensity of the animation or flashing indicator represents a known range of failure probability.

19. The method of claim 11 further comprising undertaking a remedial course of action based on the predicted risk state of at least one of the side streams.

20. The method of claim 19, wherein undertaking the remedial course of action comprises one or more of the following:
changing the one or more process parameters;
changing a maintenance schedule for a portion of the complex industrial process; and
performing maintenance on a portion or component of the complex industrial process.
